(19) United States
(12) Patent Application Publication
(10) Pub. No.: US 2006/0274357 A1
(43) Pub. Date: Dec. 7, 2006

(54) Systems and methods for digital image printing

(76) Inventor: Zhongming Shen, Sunnyvale, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/144,845

(22) Filed: Jun. 3, 2005

(51) Int. Cl. G06F 3/12; G06F 15/00

(52) U.S. Cl. 358/1.15; 358/527

(57) ABSTRACT

Systems and methods consistent with embodiments of the present invention provide a method for the direct printing of images from digital imaging devices. In some embodiments, an image is received from a digital imaging device and sent to a computer for processing. In some embodiments, after the computer has completed the processing of the image, the processed image is sent to a printer where it is printed. In some embodiments, the image may be received by a printer from a digital imaging device connected to the printer and then forwarded to a computer for processing. In some embodiments, the digital imaging device may be a PictBridge enabled device. In some embodiments, a printer may receive images from a PictBridge enabled device connected to it, have the images processed remotely by a computer accessible from the printer, receive the processed image from the computer and then print the processed image.

### BACKGROUND

1. Field of the Invention

The present invention relates to the field of digital image printing and in particular, to mechanisms to process and print digital images captured via digital imaging devices.

2. Description of Related Art

Digital cameras are growing increasingly popular with users because of the ease with which images taken using such cameras may be stored and processed. Images taken by digital cameras may be transferred to personal computers where they may be processed, indexed, and stored indefinitely without the loss of quality or degradation of the images associated with traditional film cameras. To allow users even more flexibility many recent digital cameras and printers, offer users the capability to directly print images stored in a digital camera without complicated operations on a personal computer. Direct printing eliminates the need for users to interact with user interfaces and printer control programs on a computer, in order to print images from their digital cameras.

Images in digital cameras are normally stored in a format specified by the Joint Photographic Experts Group (“JPEG”). The JPEG format allows images to be compressed so that they use less memory and storage space in the digital camera, where these resources may be particularly scarce. Therefore, in order to print digital images directly from a digital camera, printers offering the direct print capability must be capable of receiving digital images directly from a digital camera, rendering the received image by transforming the image from its compressed format into a bitmapped image, performing additional processing on the rendered image such as color matching, and creating a raster image that is suitable for printing. Color matching refers to the processing of color data to ensure that colors displayed on a computer or a digital camera screen closely matches the colors in printouts.

Most printers already have ports to receive data, and additional ports may be provided at a fairly low cost. However, low-cost printers may not provide the additional support needed to directly print images. Moreover, even where a printer provides the requisite support, image processing functions are generally performed by software on account of the high cost of image processing hardware. Such software-based image processing solutions are inherently slow relative to their hardware counterparts, and thus the extra direct printing functionality added to a printer comes at a significant degradation in printer performance and speed. Accordingly, there is a need for a solution that allows printers, including low-cost printers to directly print images from digital imaging devices without compromising performance.

### SUMMARY

In accordance with the present invention, systems and methods for directly printing images from digital imaging devices are presented. In some embodiments, an image is received from a digital imaging device and sent to a computer for processing. In some embodiments, after the computer has completed the processing of the image, the processed image is sent back to the printer where it is printed.

In some embodiments, the image may be received by a printer from the digital imaging device connected to the printer. In some embodiments, the digital imaging device may be a PictBridge enabled device. In some embodiments, a printer may receive images from a PictBridge enabled device connected to it, have the images processed remotely by a computer accessible from the printer, receive the processed image from the computer and then print the processed image.

In some embodiments, the computer may receive and process the image directly from a digital imaging device, including for example a PictBridge device connected to it, process the image and send the processed image to a printer for printing. These and other embodiments are further explained below with respect to the following figures.

### BRIEF DESCRIPTION OF THE DRAWINGS

FIG. 1 is a block diagram illustrating a system for the direct printing of images from a digital imaging device, according to one or more embodiments of the present invention.

FIG. 2 is a flowchart illustrating steps in the process of printing an image directly from a digital imaging device, according to one or more embodiments of the present invention.

FIG. 3 is a flowchart illustrating steps associated with the direct printing of images, according to one or more embodiments of the present invention.

FIG. 4 is a block diagram illustrating interactions between components of one exemplary system for the direct printing of digital images, according to one or more embodiments of the present invention.

FIG. 5 is a block diagram illustrating between components of another exemplary system for the direct printing of digital images, according to one or more embodiments of the present invention.

FIG. 6 is a block diagram illustrating between components of yet another exemplary system for the direct printing of digital images, according to one or more embodiments of the present invention.

### DETAILED DESCRIPTION

In accordance with the present invention, systems and methods for directly printing images from digital imaging devices are presented. In some embodiments, an image (in other words, image data) is received from a digital imaging device and sent to a computer for processing. In some embodiments, after the computer has completed the processing of the image, the processed image (in other words, printable image data) is sent to a printer, where it is printed. In some embodiments, image data is sent to a computer by the digital imaging device, where it is processed and then sent to a printer. The image is then printed by the printer according to prior user instructions that were input into the digital imaging device. In some embodiments, the user need not input any instructions into the computer directly and the images are automatically processed and sent to the printer.

In some embodiments, the image may be initially received by a printer from a digital imaging device connected to the printer. In some embodiments, the digital imaging device may be a PictBridge enabled device. PictBridge is an industry standard established by CIPA (Camera and Imaging Products Association) that allows images from digital cameras to be printed directly on a printer, without the intervention of a computer. PictBridge compliant devices are inter-operable, and thus enable direct print solutions to be implemented across PictBridge compliant products regardless of manufacturer. PictBridge enables users to directly print images from any PictBridge compliant digital camera to any PictBridge compliant printer. In some embodiments, a printer may receive images from a PictBridge enabled device connected to it, have the images processed remotely by a computer accessible from the printer, receive the processed image from the computer and then print the processed image. In some embodiments, image data is sent to a computer by the digital imaging device, where it is processed and then sent to a printer. The image is then printed by the printer according to prior user instructions that were input into the digital imaging device. In some embodiments, no user-input to the computer is needed and the images are automatically processed by the computer and sent to the printer.

In some embodiments, the computer may receive and process the image directly from a digital imaging device, including for example a PictBridge device connected to it, process the received image to produce printable image data, and send the processed image to a printer for printing.

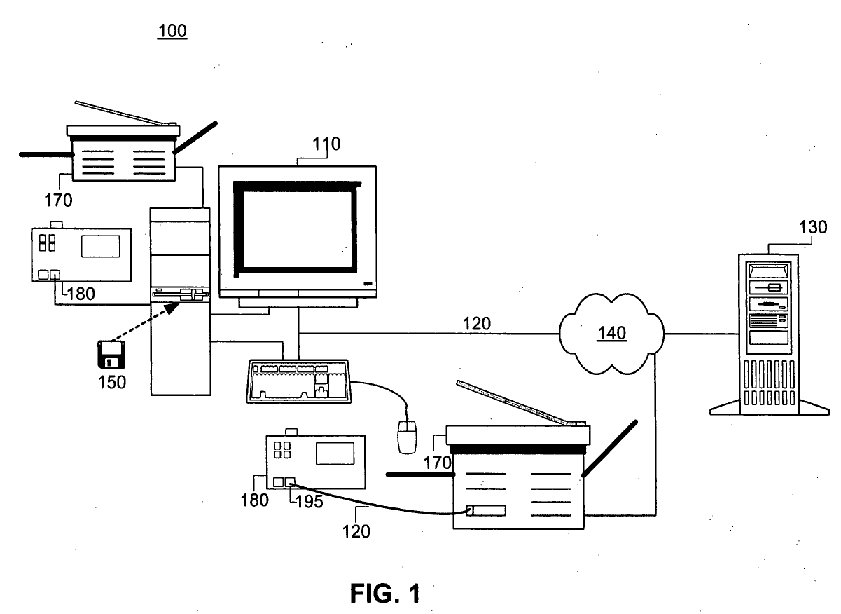

FIG. 1 shows a block diagram of a system for the configuration of peripheral devices according to some embodiments of the invention. A computer software application consistent with the present invention may be deployed on a network of computers, as shown in FIG. 1, that are connected through communication links that allow information to be exchanged using conventional communication protocols and/or data port interfaces.

As shown in FIG. 1, exemplary system 100 includes computers including a computing device 110 and a server 130. Further, computing device 110 and server 130 may communicate over a connection 120, which may pass through network 140, which in one case could be the Internet. In this specification, the term “computer” is used broadly to include computing devices and servers. Computing device 110 may be a computer workstation, desktop computer, laptop computer, any processor/server, or any other computing device capable of being used in a networked environment. Server 130 may be a platform capable of connecting to computing device 110 and other devices (not shown). Computing device 110 and server 130 may be capable of executing software (not shown) that allows the printing of images from digital imaging device 180 using printer 170.

Printer 170 may also be capable of directly printing images received from digital imaging device 180 over connection 120. In some embodiments, digital imaging device 180 may be a digital camera or any other storage device that holds digital images capable of communicating with printer 170, computing device 110 or server 130 through ports 195 provided on the digital imaging device 180. In some embodiments, one or both of digital imaging device 180 and printer 170 may be PictBridge compatible. PictBridge refers to the Digital Photo Solutions standard of the Camera and Imaging Products Association (“CIPA”) denoted as CIPA DC 001 or later versions, and incorporated herein by reference.

As shown in FIG. 1, digital imaging device 180 can also be connected with computing device 110 directly. This arrangement still affords the same direct printing of digital images, and may or may not include additional processing by the computing device 110. Note, too, that the image processing can be distributed. Thus, both the computer and/or the printer can do the same image processing, as desired, such as half-toning, color matching, and other image manipulation processes. In some embodiments, the computer can transform the image data into a first printable image data. Then, the first printable image data can be sent to the printer and be transformed into the second printable image data by the printer. The printer can print according to the second printable image data. In some embodiments, no user input to the computer is needed and image data from the digital imaging device 180 can be automatically processed by the computer and sent to the printer.

Computing device 110 also contains removable media drive 150. Removable media drive 150 may include, for example, 3.5 inch floppy drives, CD-ROM drives, DVD ROM drives, CD±RW or DVD±RW drives, USB flash drives, and/or any other removable media drives consistent with embodiments of the present invention. In some embodiments consistent with the present invention, portions of the software application may reside on removable media and be read and executed by computing device 110 using removable media drive 150.

Connection 120 couples computing device 110, server 130, and printer 170 and may be implemented as a wired or wireless connection using conventional communication protocols and/or data port interfaces. In general, connections 120 can be any communication channel that allows transmission of data between the devices. In one embodiment, for example, the devices may be provided with conventional data ports, such as Ethernet, USB, SCSI, FIREWIRE, and/or coaxial cable ports for transmission of data through the appropriate connection. In some embodiments, connection 120 may be a connection, for example, a Digital Subscriber Line (DSL), an Asymmetric Digital Subscriber Line (ADSL), or a cable connection. The communication links could be wireless links or wired links or any combination consistent with embodiments of the present invention that allows communication between the various devices.

Network 140 could include a Local Area Network (LAN), a Wide Area Network (WAN), or the Internet. In some embodiments consistent with the present invention, information sent over network 140 may be encrypted to ensure the security of the data being transmitted.

Printer 170 is connected to network 140 through connection 120. In some embodiments, printer 170 may also be connected directly to computing device 110 and/or server 130. Printer 170 may contain a processor, memory, and/or other Application Specific Integrated Circuits, and/or Field Programmable Gate Arrays (FPGAs) that are capable of executing portions of an application to directly print images according to embodiments of the invention. System 100 may also include other peripheral devices (not shown), according to embodiments of the invention. In some embodiments, printer 170 may allow paper sizes, output trays, color selections, and print resolution, among other options, to be user-configurable. In some embodiments, information transferred to and/or from the printer 170 and/or digital imaging device 180 may be stored on computing device 110 and/or server 130 for additional processing.

A computer software application consistent with the present invention may be deployed on any of the exemplary computers, as shown in FIG. 1. For example, computing device 110 could execute software that may be downloaded directly from server 130. Portions of the application may also be executed by printer 170 in accordance with embodiments of the invention.

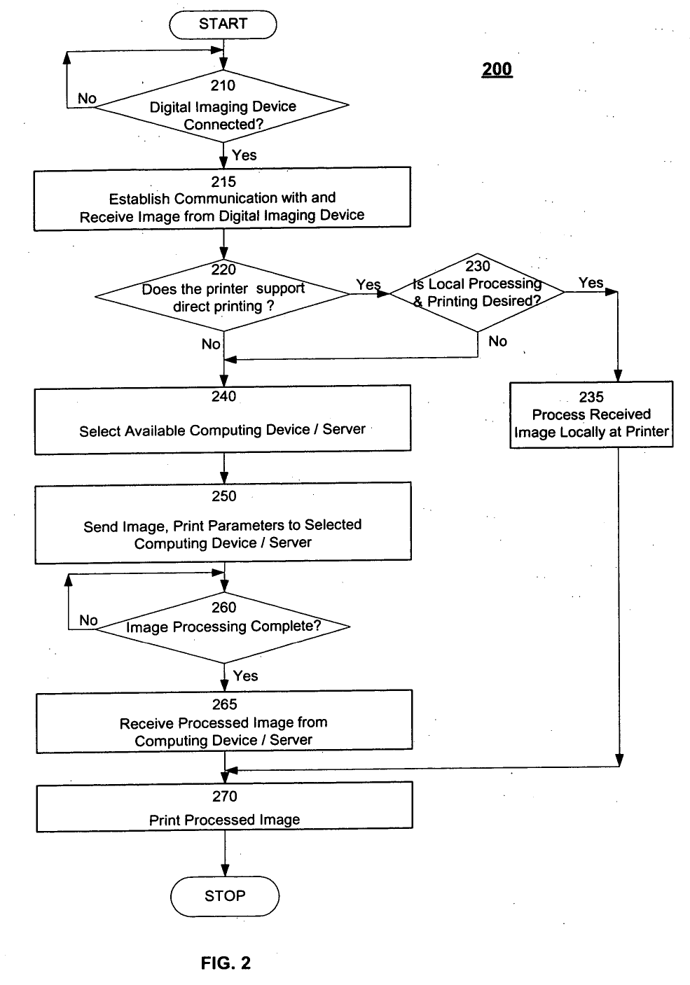

FIG. 2 is a flowchart 200 that described the printing of an image directly from a digital imaging device 180, according to one or more embodiments of the invention. In other words, in this embodiment, the printer can be directly connected with the digital imaging device. In some embodiments, algorithm 200 may be implemented by printer 170. In step 210, the algorithm is in a wait state, where it awaits the connection of a digital imaging device, such as exemplary device 180. If a digital imaging device has connected, the algorithm moves to step 215, where it communicates with the digital imaging device to receive images. In some embodiments, the communication with the digital imaging device may use an established or standard protocol. In some embodiments, the digital imaging device may be a PictBridge enabled device and the exchange of information may take place in accordance with a PictBridge compliant protocol.

In step 220, the printer receiving the image is queried to determine whether it is capable of direct printing. For example, a printer may be capable of processing and printing the images locally. Printers that do not have the capability to process the image may be able to process and print the images in accordance with methods described in the present invention. In some embodiments, images may be processed by computers remotely even if the printer has the capability to process the images.

If a printer has the capability to process images then, in step 230, the printer settings are examined to determine if the image is to be processed and printed locally. If the printer is configured to process and print images locally, then the image is processed locally in step 235, and the processed image is printed in step 270.

If the printer is not capable of processing images or if it is not configured to locally process images, then in step 240, the printer selects an available computer to which images may be sent. In some embodiments, a list of available computers may be provided to the printer. In some embodiments, the printer may use a discovery process to locate computers with the processing capability by sending messages over network 140 and determining available computers from the responses received. In some embodiments, the computer could be exemplary computing device 110 or server 130.

In step 250, the images and print parameters are sent to the selected computers. In step 260, the algorithm waits for an indication that remote processing of the image has been completed. For example, a message may be received from the selected computer that the processed image is ready. In step 265, the processed image is received from the selected computer, and the processed image is printed in step 270. In some embodiments, algorithm 200 allows printers that lack the capability to process images themselves to print images received from digital imaging devices, by having the images processed remotely on an available computer.

In the case that the digital imaging device is connected with a computer directly and the computer is connected with the printer, steps 210 and 215 are different from algorithm 200. In this embodiment, instead of step 210, the algorithm is in a wait state, where it awaits the connection of a digital imaging device through the computer. If a digital imaging device has connected through the computer, the algorithm moves to next step, where it communicates with the digital imaging device through the computer to receive images. After that, it can proceed to step 220.

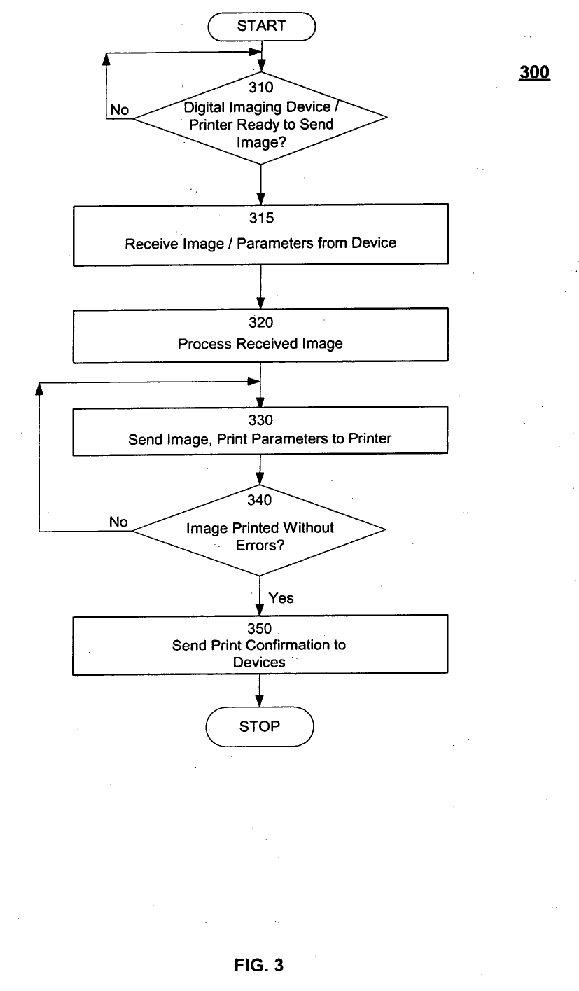

FIG. 3 depicts a flowchart 300 describing the processing of an image by a computer. In some embodiments, the computer could be exemplary computing device 110 or server 130. In some embodiments, the computer may receive an image for processing from a digital imaging device or printer directly connected to it, or from a remote device over network 140. In some embodiments the digital imaging device and/or the printer may be PictBridge enabled devices.

In step 310, the computer is in a wait state where it awaits the transmission of an image. If the device is ready to send an image, the computer receives the image and/or parameters in step 315. In step 320, the received image is processed. In some embodiments, image processing could include rendering the received image by transforming the image from its compressed format into a bitmapped image, performing additional processing on the rendered image such as color matching, and creating a raster image that is suitable for printing.

In step 330, the processed image is sent to the printer with print parameters. If the image is received and prints without errors in step 340, the printer may send an appropriate message to the computer, which may then send out a print confirmation message in step 350. If the image is not received correctly in step 340, the image and print parameters may be resent.

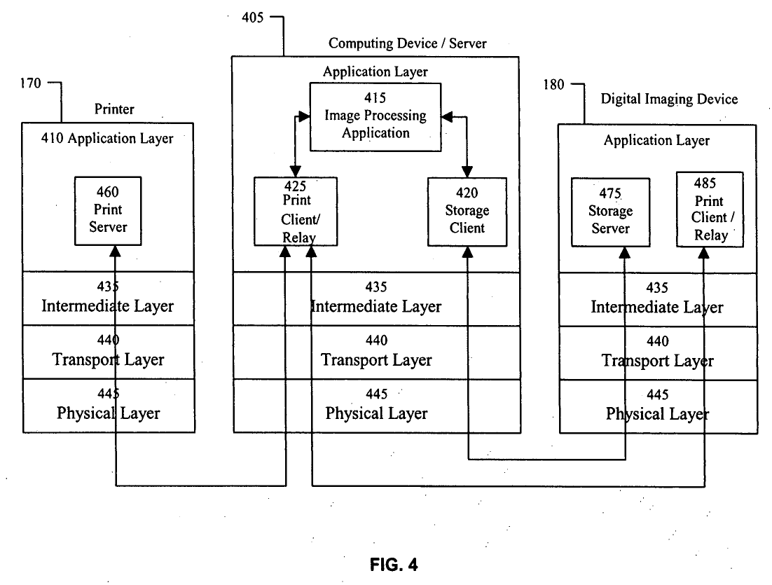

FIG. 4 shows an exemplary system for the printing of digital images according to embodiments of the invention. In this exemplary embodiment, the system includes a digital imaging device 180, computer (computing device/sever) 405, and printer 170 capable of communicating with each other. In some embodiments, applications running at the Application Layer level on each of the components communicate with each other through a protocol stack that includes Intermediate Layer 435, Transport Layer 440, and Physical Layer 445. In some embodiments, the protocol stack may be a Transport Control Protocol/Internet Protocol (TCP/IP) stack. Each layer provides services to the layers above it through a well-defined interface, while abstracting away the implementation details of the services it provides. Although communicating processes at the same hierarchy level (“peer processes”) on different hosts/devices may appear to be directly communicating with each other, the communication actually involves processes at lower layers until the lowest or “physical” layer, transmits the information over the physical medium through which actual communication occurs. At the receiving host, the information works its way up through the layers starting from the physical layer, until it reaches the level of the peer process.

In some embodiments, the digital imaging device 180 may run several applications, including exemplary print client/relay 485, and exemplary storage server 475. Print client/relay 485 can request printing and associated print attributes, monitor status, and report status information to the user. Storage server 475 manages access to physical storage, and can provide information related to image file attributes such as name, file ID, etc. to storage client 420.

Exemplary computer 405 may also run several applications including image processing application 415, storage client 420, and print client/relay 425. In some embodiments, image processing application 415 receives image data through storage client 420 from digital imaging device 180 and applies the appropriate image processing. Examples of such image processing include rotation, resizing, color matching, half toning, and other known procedures used in producing printable image data. Note that the image processing application may be performed by hardware or software or by a suitable combination of both. Printable image data may then be sent to printer 170 for printing through print client/relay.

In some embodiments storage client 420 of the computer can provide functionality allowing retrieval of image data from the digital imaging device 180 (through storage server 475) and pass this image data to the image processing application 415 for processing. Print Client 485 can also send query commands to the printer 170 through print client/relay, regarding the capabilities of printer 170, and for status updates on printer jobs. In some embodiments, these queries may be sent on behalf of the digital imaging device 180, and any received information can be passed back via storage client component 420.

In some embodiments, printer 170 may include a print server application 460. Print server 460 takes printable image data from print client component 425 of computer 405, and produces the associated printouts or printed documents. Print server 460 can also report status back to the print client component 425 in the computer 405.

According to embodiments of the invention, image data stored in digital imaging device 180, may be sent to computer 405 using storage server 475, where the image may be processed by image processing application 415 and then sent to printer 170 through print client/relay 470 and print server 460. Status information regarding the print job and/or printer may be relayed to digital imaging device 180 through print client/relay and print client 485.

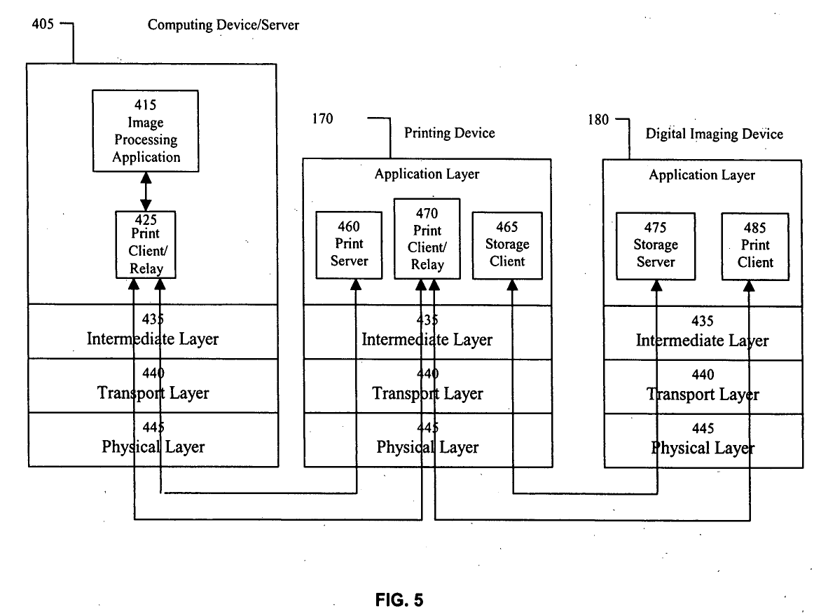

FIG. 5 shows an exemplary system for the printing of digital images according to one or more embodiments of the present invention. According to these embodiments, the printing system includes digital imaging device 180, computer (computing device/sever) 405, and printer 170 capable of communicating with each other. In some embodiments, digital imaging device 180 can request printing of stored images using storage server 475 and print client 485. In some embodiments, print requests may be relayed by printer 170 to computing device 405. In some embodiments, print client/relay 470 receives the requests and forwards the request to image processing application 415. Image processing may include functions such as image resizing, rotating, color matching, half toning, and other image manipulation functionality. The image is processed and then sent to print server 460 by print client/relay. Print server 460 can then take the printable image data from the computer 405 to produce a physical printout, and then report job status back to digital imaging device 180. In further embodiments, computer 405 can be comprised of two components, a print client component 425, and an image processing application component 415.

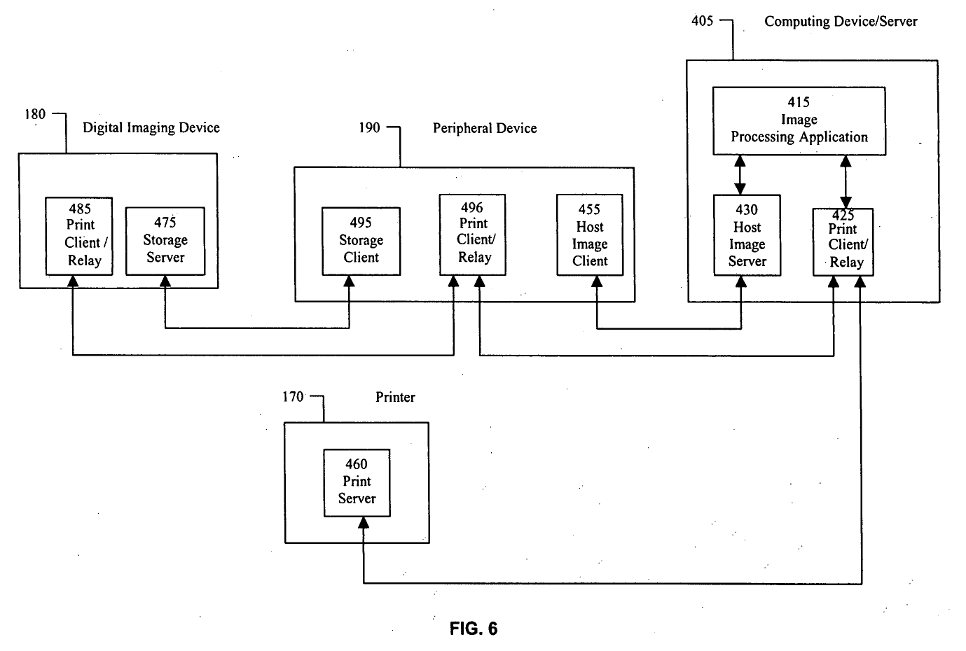

FIG. 6 shows an exemplary system for the printing of digital images according to one or more embodiments of the present invention. In the embodiments illustrated here, the system can be comprised of four components: a digital imaging device 180, a peripheral device 190, a printer 170, and a computer 405. In some embodiments, print client 485 can request printing, and can request certain associated attributes from print client/relay 496. File attribute information and stored image files needed for printing may be accessed using storage server 475 by storage client 495. In some embodiments, print client/relay 496 can fetch print job related information from print client 485, and relay this to print client/relay 425. Print client/relay 496 can also collect job status information from print server 460, and relay this back to print client 485.

In some embodiments, host image client 455 can pass any image data received to host image server 430. In this exemplary arrangement, host image server 430 can fetch unprocessed image data from host image client 455 and pass it to the image processing application 415 for processing. When print data is ready, print client/relay can send the print-ready data to the print server 460. Print server 460 can take printable image data from print client/relay of the computer 405 and produce a printout. In some embodiments, print server 460 can also report printer capability information and job status information back to print client/relay.

In some embodiments, the program for conducting the above process can be recorded on the computer-readable medium. Examples of the computer-readable medium include, but are not limited to, compact discs (e.g., CD-R, CD-RW, etc.), digital-video discs (e.g., DVD-R, DVD-RW, DVD+RW, etc.), hard drives, floppy drives, etc. Various types of computer readable memory may also be used to store programs according to embodiments of the invention. These include, but are not limited to, Read Only Memory (ROM), Programmable Read Only Memory (PROM), Flash Memory, Non-Volatile Random Access Memory (NVRAM), or digital memory cards such as secure digital (SD) memory cards, Compact Flash™, Smart Media™, Memory Stick™, and the like. In certain embodiments, the program may be delivered over a network (e.g., LAN, WAN, internet and so on).

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system comprising:
a digital imaging device, which stores image data;
a computer capable of processing the image data; and
a printer connected to the digital imaging device and the computer;
wherein the digital imaging device includes means for sending print requests and image data stored in the digital imaging device corresponding to the print requests,
the printer includes means for receiving images and print requests from the digital imaging device, and communication means including means for forwarding image data to the computer for processing and receiving printable image data from the computer, and
the computer includes means for receiving and automatically transforming the image data into printable image data, and means for sending the printable image data to the printer, whereby the printer prints the printable image data in accordance with the print request.

2. The system of claim 1, wherein the computer is physically remote from the printer and the digital imaging device.

3. The system of claim 1, wherein the means for forwarding the image data to the computer from the printer includes a data network.

4. The system of claim 1, wherein the wherein the means for forwarding the image data to the computer from the printer includes a direct connection between the printer and the computer.

5. The system of claim 1, wherein the printer is directly connected to the digital imaging device.

6. The system of claim 1, wherein the printer includes means for transforming the printable image data received from the computer into a second printable image data and means for printing according to the second printable image data.

7. The system of claim 1, wherein the digital imaging device is a PictBridge enabled device.

8. A system comprising:
a digital imaging device, which stores image data;
a computer capable of processing the image data operatively connected to the digital imaging device;
a printer operatively connected to the computer; and
wherein the digital imaging device includes means for sending print requests and image data stored in the digital imaging device corresponding to the print requests,
the computer includes means for receiving and automatically transforming the image data into printable image data, and means for sending the printable image data to the printer, whereby the printer prints the printable image data, in accordance with the print request.

9. A method comprising:
making a print request from a digital imaging device with respect to image data stored on the digital imaging device;
forwarding the image data to a computer and the print request to a printer;
transforming the image data received by the computer from the digital imaging device into printable image data;
sending the printable image data to a printer for printing, in accordance with information contained in the print request.

10. The method of claim 9, wherein the transformation of the image data received from the digital imaging device into the printable image data by the computer is accomplished without user-input to the computer.

11. The method of claim 9, wherein forwarding the stored image data from the digital imaging device to the computer occurs over a direct connection to the computer.

12. The method of claim 9, wherein forwarding the stored image data from the digital imaging device to the computer further comprises transmitting the stored image data to a printer over a direct connection between the digital imaging device and the printer, wherein the printer relays the transmitted image data to the computer.

13. The method of claim 9, wherein the digital imaging device is a PictBridge enabled device.

14. A computer-readable medium that stores instructions, which when executed by a processor perform steps in a method for printing image data, the steps comprising:
making a print request from a digital imaging device with respect to image data stored on the digital imaging device;
forwarding the image data to a computer and the print request to a printer;
transforming the image data received by the computer into printable image data; and
sending the printable image data to a printer, for printing in accordance with information contained in the print request.

15. The computer-readable medium of claim 14, wherein the step of transforming the image data received from the digital imaging device into printable image data is accomplished without user-input to the computer.

16. The computer-readable medium of claim 14, wherein the step of forwarding image data stored in the digital imaging device to the computer further comprises the steps of:
transmitting the image data to the printer over a direct connection between the digital imaging device and the printer; and
sending the image data from the printer to the computer.

17. The computer-readable medium of claim 14, wherein the step of forwarding image data stored in the digital imaging device to the computer further comprises the step of sending the image data directly to the computer.

18. A system comprising:
a digital imaging device, which stores image data;
a computer capable of processing the image data;
a printer operatively connected to the digital imaging device; and
wherein the digital imaging device sends a request to print image data stored in the digital imaging device along with the stored image data,
the printer forwards the image data to the computer for processing,
the computer receives and transforms the image data into printable image data, and
the computer sends the printable image data to the printer, to print the printable image data in accordance with the print request.

19. A system comprising:
a digital imaging device, which stores image data;
a computer capable of processing the image data operatively connected to the digital imaging device;
a printer operatively connected to the computer; and
wherein the digital imaging device sends a request to the computer to print image data stored in the digital imaging device along with the stored image data,
the computer receives and automatically transforms the image data into printable image data, and
the computer sends the printable image data to the printer, to print the printable image data, in accordance with the print request.

20. A computer readable memory containing instructions for controlling a processor to perform steps in a method for printing image data, the steps comprising:
making a print request from a digital imaging device with respect to image data stored on the digital imaging device;
forwarding the image data to a computer for processing and the print request to a printer;
transforming the image data received by the computer into printable image data; and
sending the printable image data to a printer, for printing in accordance with information contained in the print request.
